(19) United States
(12) Patent Application Publication
(10) Pub. No.: US 2009/0049104 A1
(43) Pub. Date: Feb. 19, 2009

(54) Method and system for configuring a variety of medical information

(76) Inventor: William Pan, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/285,839

(22) Filed: Oct. 15, 2008

Related U.S. Application Data
(63) Continuation-in-part of application No. 11/147,199, filed on Jun. 8, 2005.

(51) Int. Cl. G06F 17/30

(52) U.S. Cl. 707/104.1; 707/E17.009

(57) ABSTRACT

A method and a device for configuring a variety of medical information formats are described. The method is used to incorporate a variety of medical information so as to output documents in a certain format and search for information of the patient's medication history. According to one of the preferred embodiments, the medical information is automatically extracted from the pixel of an image. Thus, the device and the method are used to relieve physician's workload.

### CROSS-REFERENCE TO RELATED APPLICATIONS

This application is a Continuation-in-Part of application Ser. No. 11/147,199, filed on 8 Jun. 2005, and entitled METHOD AND DEVICE FOR CONFIGURING A VARIETY OF MEDICAL INFORMATION.

### BACKGROUND OF THE INVENTION

1. Field of the Invention

The present invention relates to a method and a system for configuring a variety of medical information, and in particular to a method and a system for converting a variety of medical information into a searchable format document by a configuration profile.

2. Description of Related Art

A patient's medical history has hundreds of documents when he is hospitalized. The hundreds of documents are inputted into computers and saved as a certain format by medical staff. Besides, every department employs different kinds of documents. For example, the WORD processor is utilized in the Otolaryngology department, while EXCEL spreadsheets are employed in the dental department. Another department uses another software to record the patient's medical history. When the medical center needs all documents recorded in the medical history to make a collective medical treatment for patients, a physician receives medical reports created by different software platforms. A lot of appliance software must be installed in a physician's computer to allow him or her to open medical reports created by the different software applications. Thus, it is not convenient for a physician to diagnose a patient's disease.

Quite a few techniques exist to solve the above problems. Taiwan Patent Publication No. 548557, entitled “A method and device for fast category searching and interconnecting”, discloses that an user provides information to generate an electronic document in a predefined document description format. Taiwan Patent Publication No. 548557 also discloses a method and a device for automatically generating related electronic documents so that users obtain search result and hyperlinks for related information generated in real time.

Taiwan Patent Publication No. 573258, entitled “A mapping method for document content and meta data”, discloses a method for mapping concept and keyword comparison to map certain paragraph of the document content to document content with different tags by meta data.

Taiwan Patent Publication No. 594532, entitled “A medical information device and a method for integrating patient's medication history information using the device”, discloses a method for integrating patient's medication history distributed in different hospitals and different departments and transmitting the patient's medication history to the user's end. According to Taiwan Patent Publication No. 594532, the method searches for a logical medication name corresponding to a medication history message so that the medical information device can retrieve a data from a database to integrate into a collective object corresponding to the logical medication name. Then, the collective object is transmitted to and displayed on terminals.

Taiwan Patent Publication No. 1220485, entitled “A multicondition searching method and device for combining document conversion and similar nodes filtering”, discloses a technique for combining document conversion and similar nodes filtering. The technique is applied to search documents with multicondition to solve disadvantages of the prior art.

### SUMMARY OF THE INVENTION

It is an object of the present invention to provide a method and a system for configuring a variety of medical information and output a searchable document.

To achieve the object of the present invention, according to the preferred embodiment, Firstly, a document input unit receives the rich-formatted documents inputted from an external device. The rich-formatted document, preferably, can be a rich-text file like a Microsoft Word® document, JPG, PNG, GIF, or other image files, Excel spreadsheet file, or other types of files. After that, each format is identified. The data from the above document according to the configuration rule is retrieved. Next, according to the configuration rule, the information with a certain format is extracted from the various medical information documents. After that, the method is to configure the medical information files based on the extracted information. Particularly, the medical information files have an index file, a text file and an image file extracted from the medical information document. At last, the medical information files are stored in storage medium for further searching purpose.

### BRIEF DESCRIPTION OF THE DRAWINGS

The present invention can be fully understood from the following detailed description and preferred embodiment with reference to the accompanying drawings, in which:

FIG. 1 is a flowchart showing a method for configuring a variety of medical information according to the present invention;

FIG. 2 is a flowchart showing a summary method for configuring a variety of medical information of the present invention;

FIG. 3 shows a flowchart of a preferred embodiment of the method of configuring a variety of medical information;

FIG. 4A schematically illustrates matches between keywords and symbols according to one embodiment of the present invention;

FIG. 4B schematically illustrates an image area matches according to one embodiment of the present invention; and

FIG. 5 schematically illustrates an integrated block diagram of a system for configuring a variety of medical information formats according to the present invention.

### DETAILED DESCRIPTION OF THE PREFERRED EMBODIMENTS

The following detailed description is of the preferred contemplated modes of carrying out the invention. This description is not to be taken in a limiting sense, and is made merely for the purpose of illustrating general principles of embodiments of the invention. The scope of the invention is best defined by the appended claims.

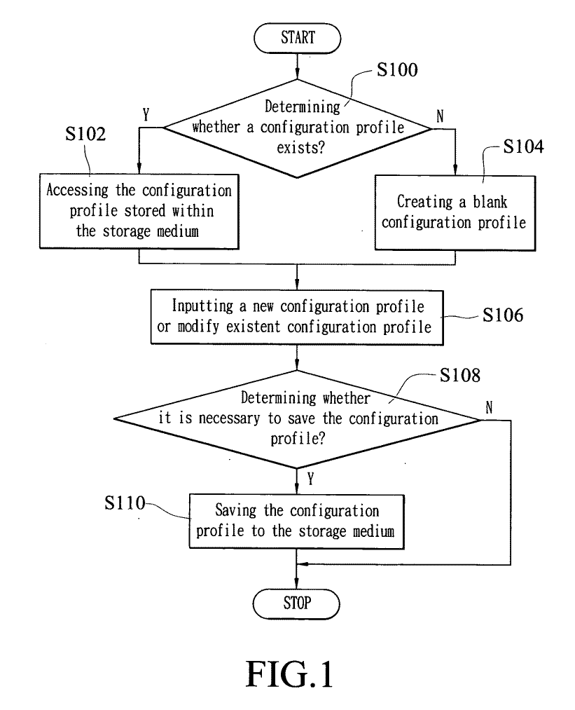

Reference is made to FIG. 1. FIG. 1 is flowchart showing a method for configuring a variety of medical information according to the present invention. The process of the flowchart is described in detail below.

Step S100: In step S100, it is determined whether a configuration profile exists. If the configuration profile exists, then the process goes to step S102. Otherwise, the process goes to step S104.

Step S102: In step S102, the present invention extracts information to generate the configuration profile and employs a portable document format to generate borderline of the configuration profile. For example, the portable document format is PDF file. Then, the process goes to step S106.

Step S104: In step S104, if the configuration profile does not exist, a blank configuration profile is created. Then, the process goes to step S106.

Step S106: In step S106, it is necessary to input a new configuration profile or modify existent configuration profile regardless of whether the configuration profile exists. Then, the process goes to step S108.

Step S108: In step S108, it is determined whether it is necessary to save the configuration profile to a storage medium. If yes, then the process goes to step S110. Otherwise, the process stops.

Step S110: In step S110, the configuration profile is saved to the storage medium.

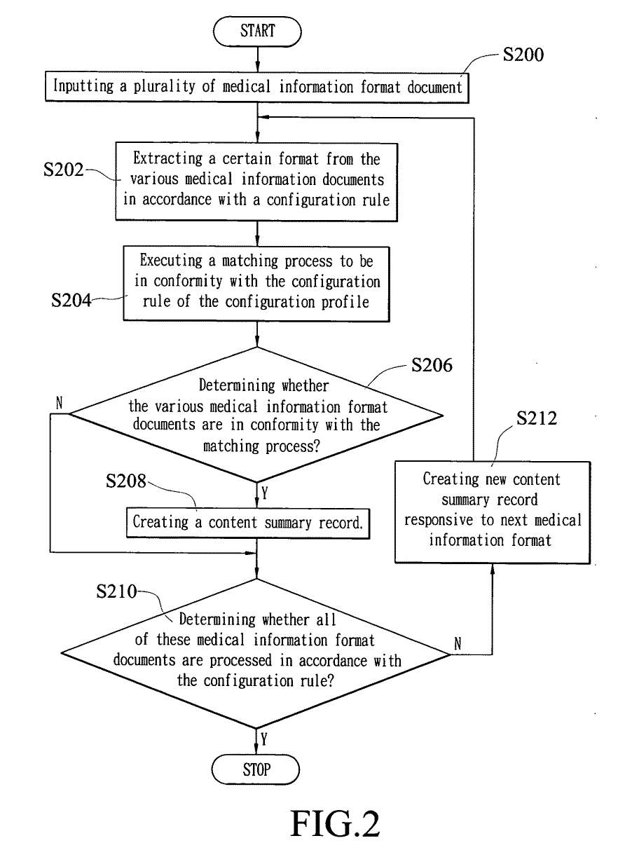

Reference is made to FIG. 2. FIG. 2 is a flowchart showing steps of the method for configuring a variety of medical information of the present invention. The process of the flowchart is described in detail below.

Step S200: In step S200, a plurality of medical information format document is sequentially input. Then, the process goes to step S202.

Step S202: In step S202, a variety of medical information documents are created by word processor software. Then, various medical information documents are edited into webpage-liked medical information supported by unified resource locator (URL), or the various medical information documents are created by any one medical information format. According to configuration rule, a certain format is extracted from the various medical information documents. Then, the process goes to step S204.

Step S204: In step S204, the present invention extracts information to generate the configuration profile and employs a portable document format to generate a borderline of the configuration profile. A matching process is executed to be in conformity with the configuration rule of the configuration profile. The configuration rule can be an identification code, a patient's name, gender, symbol, or a combination thereof. Additionally, the configuration rule can be a region of interest. The matching process matches keywords/symbols, regions of interest, or combinations thereof. The keywords/symbols matching is the default, and regions of interest matching includes part of or all characters thereof. Then, the process goes to step S206.

Step S206: In step S206, it is determined whether the various medical information format documents are in conformity with the matching process. If yes, then the process goes to step S208. Otherwise, the process goes to step S210.

Step S208: In step S208, a content summary record is created. Then, the process goes to step S210.

Step S210: In step S210, it is determined whether all of these medical information format documents are processed in accordance with the configuration rule. If yes, then the process stops. Otherwise, the process goes to step S212.

Step S212: In step S212, new content summary record is created responsive to the next medical information format. Until all of medical information format documents are processed in accordance with the configuration rule, the process of content summary stops.

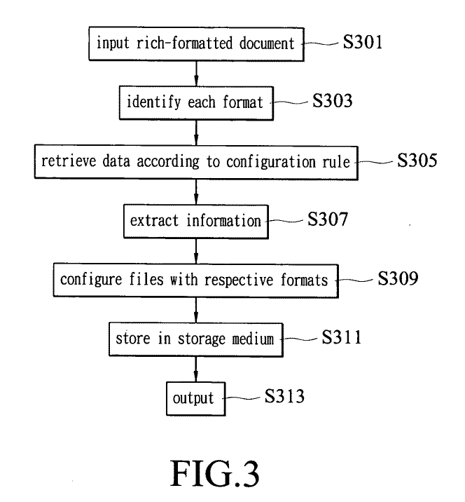

After the configuration profile is generated and a configuration rule therein is ascertained. Particularly, this configuration rule is the region of interests, accordingly, some formats are extracted from the various medical information documents. Next, reference is made to FIG. 3 that illustrates the system for configuring the medical information of the present invention. FIG. 3 shows a flowchart of the preferred embodiment of method for configuring a variety of medical information.

In step S301, a document input unit in the system receives one or more rich-formatted documents inputted from an external device. Particularly, this document (medical information document) input unit is implemented by a software program, which reads the external text, chart, or image file.

The rich-formatted document, preferably, can be a rich-text file like a Microsoft Word® document. The document can be an image file like JPG, PNG, GIF, or other image files. The document can be a chart file like an Excel spreadsheet file. The document can be other types of files having image and text.

Step S303 of the method is to identify each format of the inputted rich-formatted document since the document includes a variety of formats. After identifying the formats, the method goes to step S305 showing the system that retrieves data from the above document according to the configuration rule. The data retrieved from the document, for example, has text-formatted data, pixel-formatted data, spreadsheet/chart-formatted data and data with some other formats.

Next, according to the configuration rule, the information with a certain format is extracted from the various medical information documents by a content extract unit of the system (step S307). The information is extracted from the data such as text, image, spreadsheet, chart or their combination.

In step S309, the method is to configure a variety of medical information files with respective formats based on the extracted information. According to the configuration rule, the region of interests are shown as the extracted information. The medical information files have an index file, a text file and an image file extracted from the medical information document. Then the method goes to step S311. The medical information files are stored in storage medium. Preferably, the storage medium is formed as a database that has an output unit for outputting some useful information for further searching purpose.

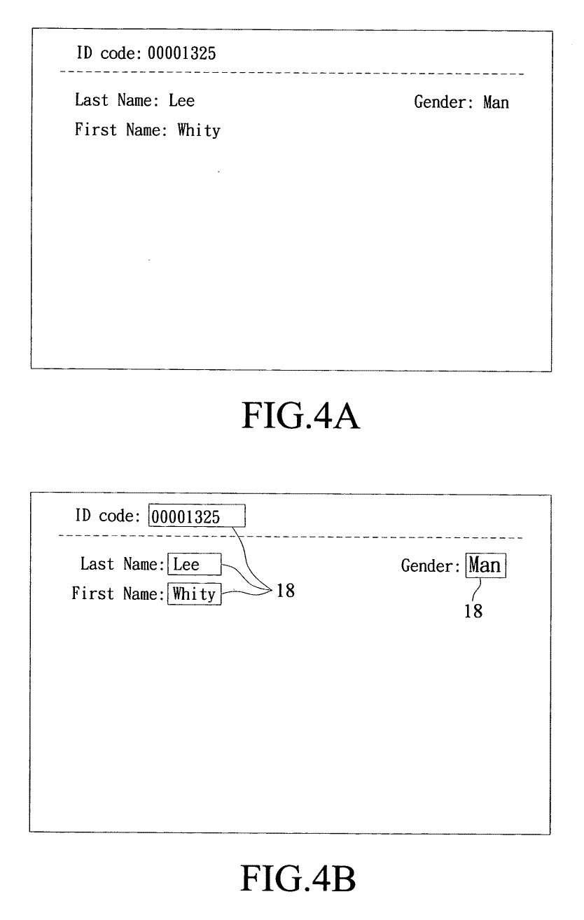

Reference is made to FIG. 4A. FIG. 4A schematically illustrates matches between keywords and symbols according to one embodiment of the present invention. The matching processing is executed by keywords, e.g. the identification code, the patient's name, the gender, the symbol or a combination thereof. In this regard, character of content summary record are 00001325, Lee, Whity, and Man.

Reference is made to FIG. 4B. FIG. 4B respectively illustrate the areas of a matched text file and a matched image file according to one embodiment of the present invention. The matching processing is executed by keywords, e.g. the identification code, the patient's name, the gender, the symbol, or a combination thereof. Additionally, characters are extracted according to a definition information 18 of respective keyword. For example, the definition information is similar to an abscissa, an ordinate, height or width. Thus, extracted characters are the same as those of FIG. 4A.

Particularly, the FIG. 4B shows the area of an image file, according to the preferred embodiment, the pixels of the image may be automatically extracted and transferred to the useful information or keywords. For example, the pixel of the image may be automatically transferred to Id, person's first name, last name and Gender. Those data can be the keywords for further searching.

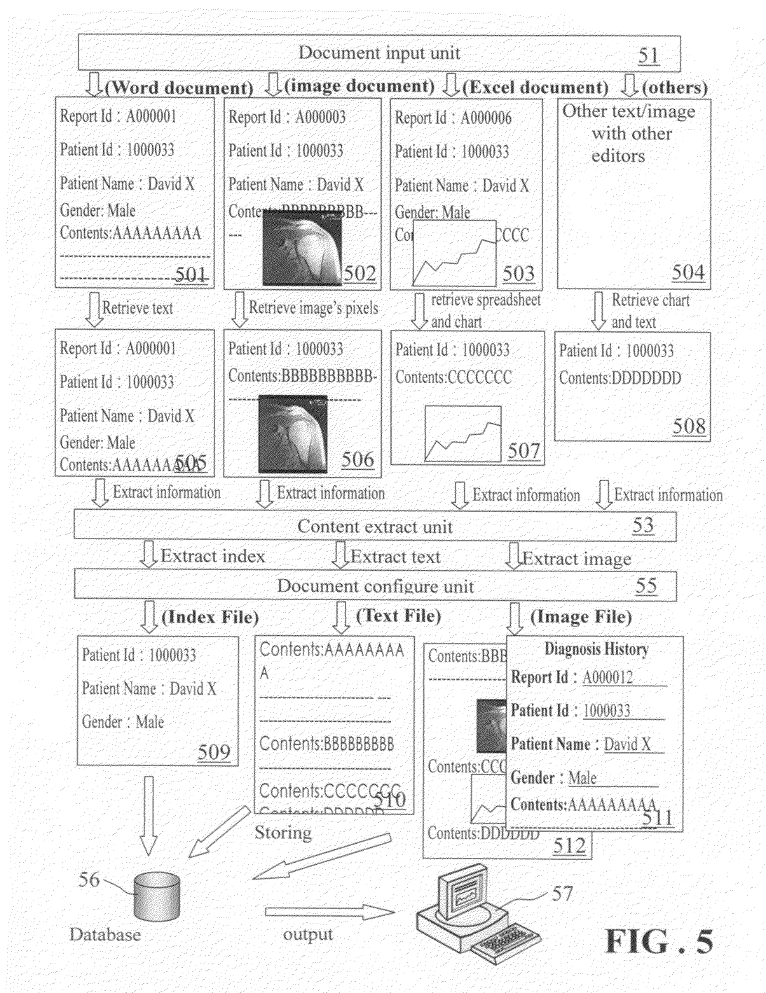

FIG. 5 illustrates an integrated block diagram of a system for configuring a variety of medical information formats according to the present invention. The document input unit 51 is included to read one or more documents inputted from external sources, especially the document is a rich-formatted document. The document input unit 51 receives the external text, image, spreadsheet/chart, or the document with some other formats in an exemplary example. As shown in FIG. 5, those formats are such as Microsoft Word® document (501), image document (502), spreadsheet/chart document (preferably the Microsoft Excel®, 503), and other formatted documents (504). The system then retrieves some data from those documents according to the configuration rule. According to the exemplary example shown in FIG. 5, the text-formatted data 505 is retrieved from the Microsoft Word® document 501, the pixel-formatted data 506 is retrieved from the image document 502, the spreadsheet/chart-formatted data 507 is retrieved from the Microsoft Excel® document 503, and the data with some other formats 508 is retrieved from the other formatted document 504.

Those retrieved data are extracted into the content extract unit 53 of the system, particularly this unit 53 extracts medical information having index, text and image from the data. Thereby, the region of interests can be obtained since the region is extracted from those data according to the configuration rule. Next, the document configure unit 55 is to configure the extracted medical information to some files such as the index file 509, text file 510, image file 512 or their combination (511) with respective formats according to the configuration rule.

At last step, those files 509, 510, 511, 512 are stored in the storage medium 56, which may output the useful information to the terminal computer 57 through an output unit (not shown).

As described above, the present invention provides fast searching when the physician diagnoses patients by the document in a certain format. Besides, the physician needs not read several medical information format documents to relieve the physician's workload.

While the invention has been described with reference to the preferred embodiments, the description is not intended to be construed in a limiting sense. It is therefore contemplated that the appended claims will cover any such modifications or embodiments as may fall within the scope of the invention defined by the following claims and their equivalents.

What is claimed is:

1. A method for configuring a variety of medical information, the steps comprising:
identifying a plurality of formats existed in an inputted rich-formatted document;
retrieving data therein with corresponding format according to a configuration rule;
extracting a variety of medical information based on the configuration rule;
configuring the information to a plurality of files with respective formats according to the configuration rule; and
storing the file in a storage medium.

2. The method of claim 1, wherein the configuration rule is the region of interests.

3. The method of claim 1, wherein the inputted rich-formatted document is a medical information document.

4. The method of claim 1, wherein the rich-formatted document is inputted from an external device.

5. The method of claim 4, wherein the rich-formatted document is a rich-text file, spreadsheet/chart file, an image file, or the combination.

6. The method of claim 5, wherein the medical information is automatically extracted from the pixels of the image file.

7. The method of claim 6, wherein the extracted information is transferred to an Id, a person's first name, last name and Gender.

8. The method of claim 1, wherein the data retrieved from the document is text-formatted data, pixel-formatted data, spreadsheet/chart-formatted data, or data with some other formats.

9. The method of claim 1, wherein the information is configured to an index file, a text file, or an image file.

10. A system for configuring a variety of medical information, comprising:
document input means, which reads one or more documents inputted from external sources, wherein the document is a rich-formatted document;
data retrieving means, which retrieves data in the document according to a configuration rule;
content extracting means, which extracts medical information having index, text and image from the data;
document configuring means, which configures the extracted medical information to a plurality of files with respective formats; and
storing means, which stores the files in a storage medium.

11. The system of claim of 10, further comprising output means for outputting the files in the storage medium.

12. The system of claim 10, wherein the document is extracted to text-formatted data, pixel-formatted data, spreadsheet/chart-formatted data, or the data with some other formats.

13. The system of claim 10, wherein the files stored in the storage medium includes an index file, a text file, or an image file.

14. The method of claim 13, wherein the medical information is automatically extracted from the pixels of the image file.

15. The method of claim 14, wherein the extracted information is transferred to an Id, a person's first name, last name and Gender.
